(19) United States
(12) Patent Application Publication
(10) Pub. No.: US 2024/0022428 A1
(43) Pub. Date: Jan. 18, 2024

(54) METHOD FOR MULTI-PARTY AUTHENTICATION USING DISTRIBUTED IDENTITIES

(71) Applicant: GEROMICS LTD, Cambridge (GB)

(72) Inventors: Carlos Massiah, Cambridge (GB); Daniel Murray Bolser, Cambridge (GB)

(21) Appl. No.: 18/044,820

(22) PCT Filed: Aug. 10, 2021
(86) PCT No.: PCT/GB2021/052058

§ 371 Date: Mar. 10, 2023

(30) Foreign Application Priority Data
Aug. 11, 2020 (GB) 2012478.0

(51) Int. Cl. H04L 9/32; H04L 9/08

(52) U.S. Cl. CPC H04L 9/3247; H04L 9/0825; H04L 9/321; H04L 2209/46

(57) ABSTRACT

Broadly speaking, embodiments of the present techniques provide systems and methods for authenticating users using distributed identity documents, and in particular to systems and methods for multi-party authentication of users using distributed identity documents for enhanced security.

The present techniques generally relate to systems and methods for authenticating users using distributed identity documents, and in particular to systems and methods for multi-party authentication of users using distributed identity documents for enhanced privacy and security.

A user may subscribe to or sign-up to use the services of a particular company, or may purchase a service from a company. For example, a user may sign-up to a platform which stores and analyses data collected from a smartwatch or sports watch worn by the user. In another example, a user may pay for a company to perform genomic analysis on their own DNA. In many cases, the platform owner, service provider or company (i.e. third party) owns the data and any analysis performed on the data. Typically, users or individuals do not have any control over the data that the third party has collected or obtained, and do not have any control over how the third party may use the data or share the data with other companies.

The present applicant has identified the need for a method and system that allows users to securely store and share their data and to control who can access their data, as well as to authenticate themselves with services and service providers who require access to specific data.

In a first approach of the present techniques, there is provided a method, performed by a co-signing platform, for authenticating users using an authentication technique specified in distributed identity documents, the method comprising: receiving, from a user among the users, a co-signing request (also referred to herein as ‘a second request’) to co-sign an authentication request (also referred to herein as ‘a first request’) for a third party service provider, the authentication (first) request comprising a message from the third party service provider specifying that the third party requires the user to be authenticated or that the third party requires access to user data belonging to the user; determining whether the user and the co-signing (second) request are valid; signing the authentication request, when the user and request are determined to be valid, using a private key of a public-private key of a key pair of the co-signing platform; and transmitting the signed authentication request to the user for signing by the user for authenticating the user to the third party.

Advantageously, the present techniques enable a user to forward an authentication request that is received from a third party to a co-signing platform, get a signed authentication request back, and co-sign the signed authentication themselves before providing it to the third party. This means the authentication request is multi-signed, i.e. signed by multiple parties. That is, the co-signing platform is not a proxy for the user, but instead is a co-signer. The co-signing platform therefore has no access rights to any data or services that the user is requesting from the third party because the user is required to apply their signature to the signed authentication request after the co-signing platform has applied its signature. In other words, the user is the second entity to apply a signature to the authentication request, and the user transmits the co-signed authentication request back to the third party. In this way, the co-signing platform does not act on the user's behalf in any way with respect to the third party.

A distributed identity (also known as a decentralised identity, and referred to here as a DID) is a type of identity which is fully under the control of a user account/person or device who is the subject of the identity, and is independent from any centralised registry, identity provider or certificate authority. A DID allows individuals to securely and privately store all elements of their digital identity in a way that allows them to control who can access these elements and how these elements are used. The present techniques enable a DID to be used by a user to authenticate themselves to a third party, specifically by enabling multi-party authentication. The present techniques enable a user to authenticate themselves to a third party, whose services they may wish to access, by presenting to the third party a message that has been co-signed by the user and a trusted co-signing platform. Thus, multi-party authentication is achieved. The present techniques also use a multisignature (or multisig) to provide a challenge response login.

The present techniques use this authentication method if the authentication method is presented in or is part of a distributed identity document associated with the user. Advantageously, this method may appear to the third party to be similar to other authentication methods, but the details of how the valid authentication was constructed would remain unknown to the third party. In other words, the third party would not know or be able to see the underlying security techniques chosen by the user to authenticate themselves to the third party. The present techniques may be used to enhance security and may be particularly suitable for credentials or user information that is of high value.

As explained in more detail below, the authentication request comprises a message from the third party specifying that the third party requires the user to be authenticated or that the third party requires access to user data belonging to the user. Thus, in some circumstances, the multi-party/multi-signature authentication technique is performed to authenticate a user to the third party so that the user can be granted access to data held by or a service provided by the third party. In other circumstances, the user may need to provide specific private user data to the third party in order to make use of the service provided by the third party. In this case, the multi-party/multi-signature authentication technique is performed to authenticate a user to the third party so that the user can grant access to the third party to the specific user data required by the third party to provide the service.

The method performed by the trusted co-signing platform may further comprise transmitting, to the user, a failure message when one or both of the user and the co-signing (second) request are determined to be invalid. For example, if the user is not a registered user, the co-signing platform may not be able to co-sign the authentication (first) request because the user is unknown to the platform. Thus, determining whether the user is valid may comprise determining whether the user is registered with the co-signing platform.

Once the user has been determined to be valid, the platform may check the validity of the co-signing request itself. The validity of the co-signing request may be determined in a number of ways. For example, if the user transmits a signature of the request generated using their private key (of a public-private key pair belonging to the user) with their co-signing request, the method may comprise determining whether the received signature has been signed with a key corresponding to a stored public key belonging to the user. A user may have created a plurality of public-private key pairs (e.g. one key pair for each device they use), and provided the public keys of the key pairs to the platform for association with the user. The user may use any of these public keys when signing the authentication request.

Furthermore, the user may have informed the platform that one or more keys need to be revoked. In cases when a private key is lost or stolen, a user may want to revoke existing public keys from the co-signing platform. The user can revoke registered devices (keys) from their account with the platform. The user may use another (uncompromised) device to initiate the removal request. Such a signed removal request message sent by the user is stored by the platform in the user's account. Alternatively, the user may need to perform additional, policy-specific authentication steps in order to make the removal request valid. The platform will then remove the key from the stored keys associated with the user. Thus, if the platform receives a request from the user comprising a public key that has been revoked by the user, the platform may determine that the request is not valid and may refuse to co-sign.

Determining whether the co-signing request is valid may comprise obtaining, from storage, a set of policies associated with the user, the set of policies specifying conditions under which a co-signing request from the user would be valid. For example, the user can set or provide policies specifying when the co-signing platform should or should not co-sign an authentication request for the user. By default, the co-signing platform may not co-sign authentication requests when the co-signing request appears suspicious or is determined to be suspicious by the co-signing platform itself.

The user has the best knowledge about what would be improved or acceptable security for them, and therefore, the platform may enable the user to specify allowed geographic regions, IP addresses or devices from which requests would be acceptable, or times of day when co-signing requests would be expected from the user. Policies may be applied on a per-key basis, allowing different devices to have different limitations. The policies may also specify out-of-band security measures. As a simple example, the user may want the platform to provide a password challenge or device-based biometric to determine that the request has originated from the user and not from a malicious third party. A more advanced security measure may involve a telephone call to the user to validate the request. Advantageously, the user can group third parties into different risk categories that reflect the user's personal risk profile, wherein each one of the risk categories may have a different policy associated with it. The policies may be based on various datatypes requested by the third party, such as a name, nickname, physical address, bank details, genomic data, etc.

It will also be appreciated that the user may set a policy that covers policy updates. That is, the user may set a policy that specifies that any policy changes should themselves be queried by, or subject to additional checks by, the co-signing platform, in case the policy changes are being made by a malicious third party. For example, the policy may require the co-signing platform to call the user before implementing any policy change.

It will also be appreciated that the co-signing platform may provide the user with a virtual “panic button”. When the user activates the panic button, all logins and/or data access requests may be immediately and temporarily rejected. The user has the ability to disable the panic button and resume normal operation. A policy may be set for the use of the panic button. The panic button may be a feature in and/or accessible via the user device.

Thus, the method may further comprise comparing metadata associated with the received co-signing request with the set of policies; and determining the received request is valid if the metadata complies with the set of policies. The set of policies may comprise any one or more of: time of request receipt, at least one time period during which co-signing is permitted, at least one time period during which co-signing is not permitted, origin of request, geographical origin of request, device used to send request, at least one approved user device, and at least one accepted IP address. Additionally or alternatively, the set of policies may comprise at least one out-of-band security challenge to be correctly completed by the user to determine if the received request is valid.

The set of policies may be associated with each public key belonging to the user. Alternatively, the set of policies may be associated with the private key used by the user to sign the authentication request.

As explained in more detail below, in some cases determining whether the co-signing request is valid may comprise the co-signing platform making a determination itself rather than (or in addition to) relying on the set of policies. For example, the co-signing platform may comprise an artificial intelligence (AI) module running an AI model or trained machine learning (ML) model which is able to determine or make predicitions about whether a co-signing request is suspicious. The AI or ML model may be trained based on the user's own behaviour for example.

Prior to being able to co-sign authentication requests for a user, the user must register with the co-signing platform. Thus, the method may comprise an initial registration process, which may comprise: receiving, from the user, a registration request; prompting the user to generate at least one public-private key pair; requesting, from the user, the public key of each generated public-private key pair; and storing each received public key in association with the user. Separately, the user may need to update any existing distributed identity documents (DIDs) associated with the user to include this new authentication method within the DIDs. This may comprise removing any existing authentication methods from the DIDs. Thus, the user may contact an external data access platform or external DID storage platform which stores the user's DIDs to update the DIDs to contain/specify the new authentication method, so that a third party viewing a DID would know how to authenticate the user.

In some cases, the co-signing platform may be part of a system which also stores DIDs for users. In this case, the method may further comprise: receiving, from the user, a distributed identity document comprising an associated authentication method to be used by a third party to authenticate the user; and storing the received distributed identity document. Alternatively, the method may comprise: receiving, from the user, an updated distributed identity document comprising an associated authentication method to be used by a third party to authenticate the user; and replacing an existing distributed identity document in storage with the updated distributed identity document.

The method may further comprise: receiving, from the user, a set of policies specifying conditions under which a co-signing request from the user would be valid and information specifying one or more public keys to be associated with the set of policies; and storing the set of policies.

In some cases, the co-signing platform may be part of a system which also stores DIDs for users. The method steps outlined above may be performed by the co-signing platform of such a system. In such cases, when a user requests access to a service provided by a third party by presenting their DID, the third party may need to determine from the DID how to authenticate the user before granting the user to the desired service. The third party may contact a data access platform in order to obtain the authentication information. Thus, the method may further comprise the following steps performed by the data access platform: receiving, from the third party, a request for a distributed identity document for the user seeking to access a service provided by the third party, the request comprising information identifying the user; identifying, using the information identifying the user, a distributed identity document corresponding to the user in storage; and transmitting the distributed identity document to the third party, the distributed identity document comprising an authentication method for the third party to authenticate the user.

In a second approach of the present techniques, there is provided a system for authenticating users using a multi-party authentication technique specified in distributed identity documents, the system comprising: a co-signing platform. The co-signing platform comprises storage for storing public keys and policies associated with each user of the system. The co-signing platform comprises at least one interface coupled to a processor for: receiving, from a user among the users, a request to co-sign an authentication request for a third party, the authentication request comprising a message from the third party specifying that the third party requires the user to be authenticated or that the third party requires access to user data belonging to the user; determining whether the user and the co-signing request are valid; signing the authentication request, when the user and request are determined to be valid, using a private key of a public-private key of a key pair of a co-signing platform; and transmitting the signed authentication request to the user for signing by the user for authenticating to the third party.

The at least one interface and processor of the co-signing platform may be further arranged to: receive, from a user, a registration request; prompt the user to generate at least one public-private key pair; request, from the user, the public key of each generated public-private key pair; and store each received public key in association with the user in the storage of the co-signing platform.

The at least one interface and processor of the co-signing platform may be further arranged to: receive, from the user, a set of policies specifying conditions under which a co-signing request from the user would be valid and information specifying one or more public keys to be associated with the set of policies; and store the set of policies in the storage of the co-signing platform.

The system may further comprise a data access platform comprising: storage for storing at least one distributed identity document associated with each user of the system; at least one interface coupled to a processor for: receiving, from a user, a distributed identity document comprising an associated authentication method to be used by a third party to authenticate the user; and storing the received distributed identity document.

The at least one interface and processor of the data access platform may be further arranged to: receive, from the third party, a request for a distributed identity document for a user seeking to access a service provided by the third party, the request comprising information identifying the user; identify, using the information identifying the user, a distributed identity document corresponding to the user in the storage of the data access platform; and transmit the distributed identity document to the third party, the distributed identity document comprising an authentication method for the third party to authenticate the user.

The at least one interface and processor of the data access platform may be further arranged to: receive, from the user, a distributed identity document comprising an associated authentication method to be used by a third party to authenticate the user; and storing the received distributed identity document in the storage of the data access platform.

The system may further comprising a user device comprising a communication module coupled to a processor and arranged to: receive from a third party, in response to an attempt by a user of the apparatus to access a service provided by the third party, an authentication request for the user to authenticate themselves using an authentication method contained in a distributed identity document, wherein the authentication request comprises a message from the third party specifying that the third party requires the user to be authenticated or that the third party requires access to user data belonging to the user; transmit, to a co-signing platform, a request to co-sign the authentication request for the third party; receive, from the co-signing platform, a signed authentication request that has been signed using a private key of a public-private key of a key pair of a co-signing platform; sign the signed authentication request using a private key of a public-private key pair belonging to the user to generate a co-signed authentication request; and transmit the co-signed authentication request to the third party for authenticating to the third party.

When the message in the authentication request specifies that the third party requires the user to be authenticated, the user device may be arranged to: receive from the third party permission to access the service provided by the third party, following receipt by the third party of the co-signed authentication request.

When the message in the authentication request specifies that the third party requires access to user data belonging to the user, the user device may be arranged to: provide, to the third party, access to specific user data stored in a user data store or personal data store.

In a third approach of the present techniques, there is provided a method performed by a user device for authenticating a user to a third party, the method comprising: receiving from a third party, in response to an attempt by a user to access a service provided by the third party, an (first) authentication request for the user to authenticate themselves using an authentication method contained in a distributed identity document; transmitting, to a co-signing platform, a co-signing (second) request to co-sign the authentication request (i.e. the first request) for the third party; receiving, from the co-signing platform, a signed authentication request that has been signed using a private key of a public-private key pair of a co-signing platform; signing the signed authentication request using a private key of a public-private key pair belonging to the user to generate a co-signed authentication request; and transmitting the co-signed authentication request to the third party for authenticating to the third party. The method may be performed by a consumer electronic device used by the user to access services provided by third parties and to contact the co-signing platform. The authentication request may comprise a message from the third party specifying that the third party requires the user to be authenticated or that the third party requires access to user data belonging to the user.

The method performed by the user device may further comprise blinding the authentication request prior to transmitting the authentication request to the co-signing platform. To prevent the co-signing platform from seeing the identity of every entity the user interacts with, the authentication request may be blinded before it is transmitted to the co-signing platform. The anonymity may be achieved by performing cryptographic message blinding, a technique introduced by David Chaum. In this technique, an authentication request or message may be disguised (also referred to as ‘blinded’) by an application running on the user device, before the authentication request is sent to the co-signing platform. The co-signing platform can sign the authentication request with its private key and transmit the signed authentication request to the user. The user may then unblind the authentication request before sending the co-signed authentication request to the requesting third party.

The method performed by the user device may further comprise unblinding the signed authentication request prior to signing and transmitting the co-signed authentication request to the third party.

When the message in the authentication request specifies that the third party requires the user to be authenticated, the method may further comprise: receiving, from the third party, permission to access the service provided by the third party, following receipt by the third party of the co-signed authentication request.

When the message in the authentication request specifies that the third party requires access to user data belonging to the user, the method may further comprise: providing, to the third party, access to specific user data stored in a user data store.

In a fourth approach of the present techniques, there is provided an apparatus for authenticating a user to a third party, the apparatus comprising a communication module coupled to a processor and arranged to: receive from a third party, in response to an attempt by a user of the apparatus to access a service provided by the third party, an authentication request for the user to authenticate themselves using an authentication method contained in a distributed identity document; transmit, to a co-signing platform, a request to co-sign the authentication request for the third party; receive, from the co-signing platform, a signed authentication request that has been signed using a private key of a public-private key pair of a co-signing platform; and transmit the co-signed authentication request to the third party for authenticating to the third party.

When the message in the authentication request specifies that the third party requires the user to be authenticated, the apparatus may be arranged to: receive from the third party permission to access the service provided by the third party, following receipt by the third party of the co-signed authentication request.

When the message in the authentication request specifies that the third party requires access to user data belonging to the user, the apparatus may be arranged to: provide, to the third party, access to specific user data stored in a user data store.

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

Implementations of the present techniques will now be described, by way of example only, with reference to the accompanying drawings, in which:

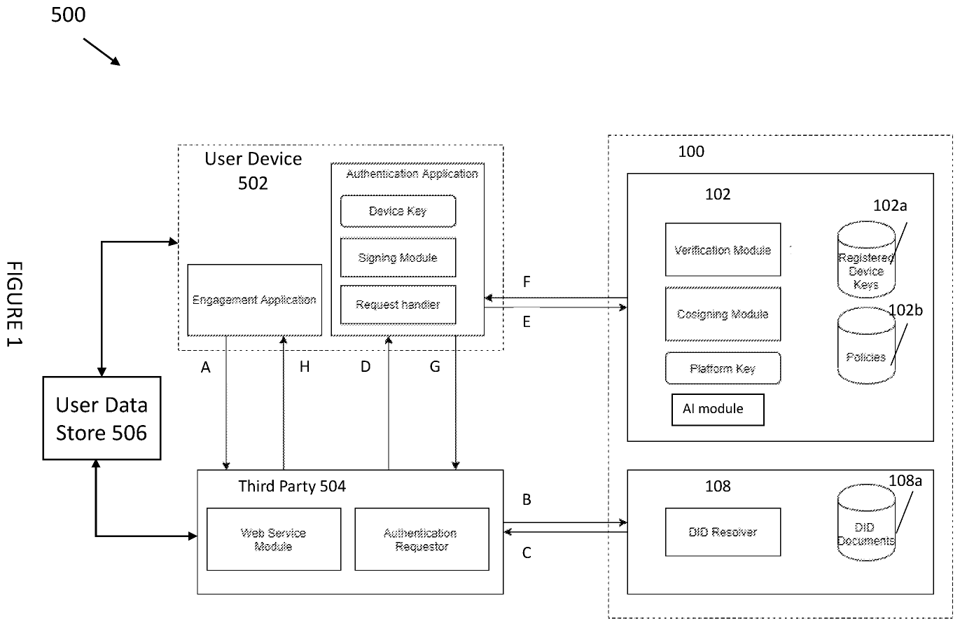

FIG. 1 shows a block diagram of a system for authenticating a user to a third party using a distributed identity document;

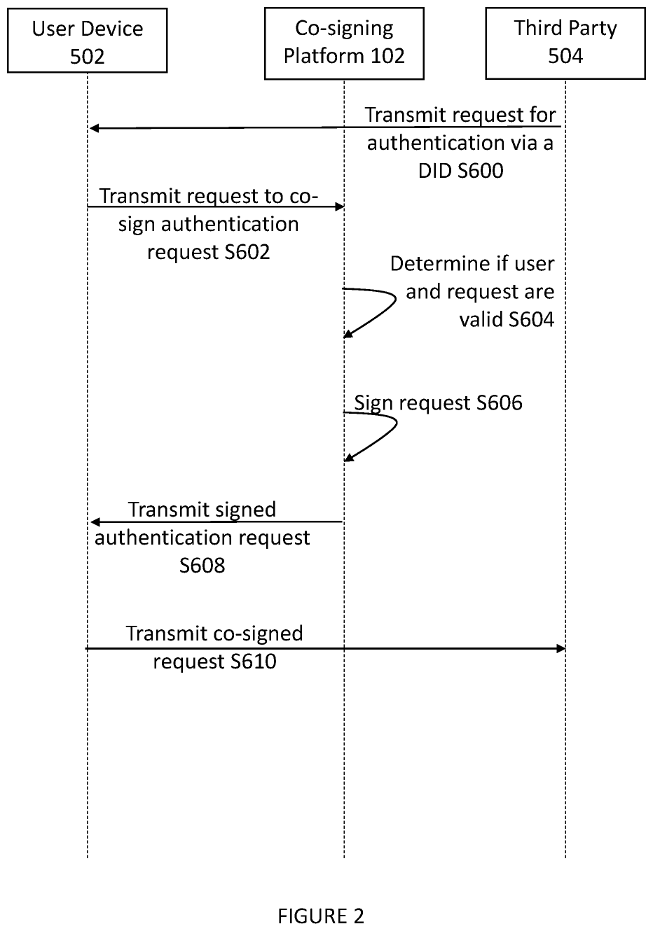

FIG. 2 shows a schematic diagram illustrating example steps to authenticate a user using a distributed identity document;

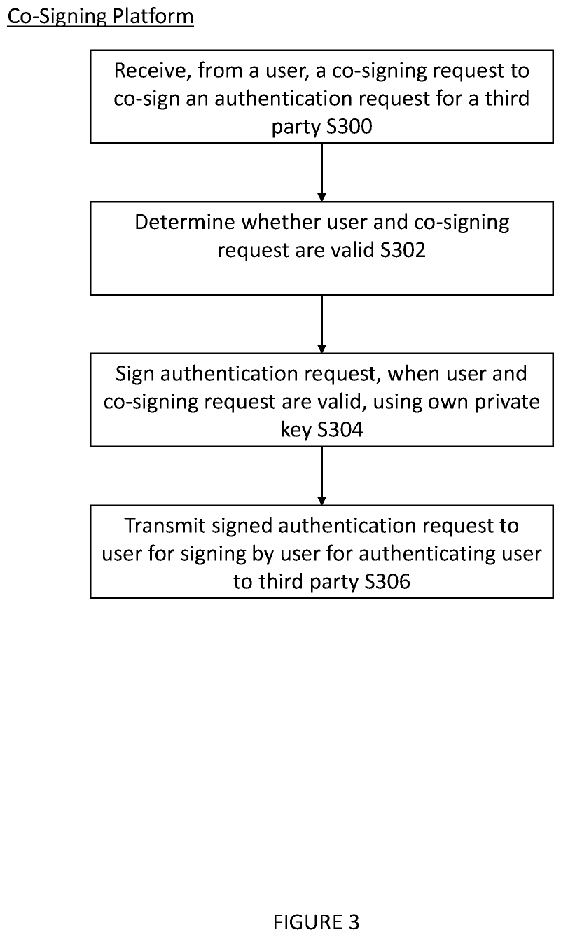

FIG. 3 shows a flowchart of example steps performed by a co-signing platform to authenticate a user using multi-party authentication;

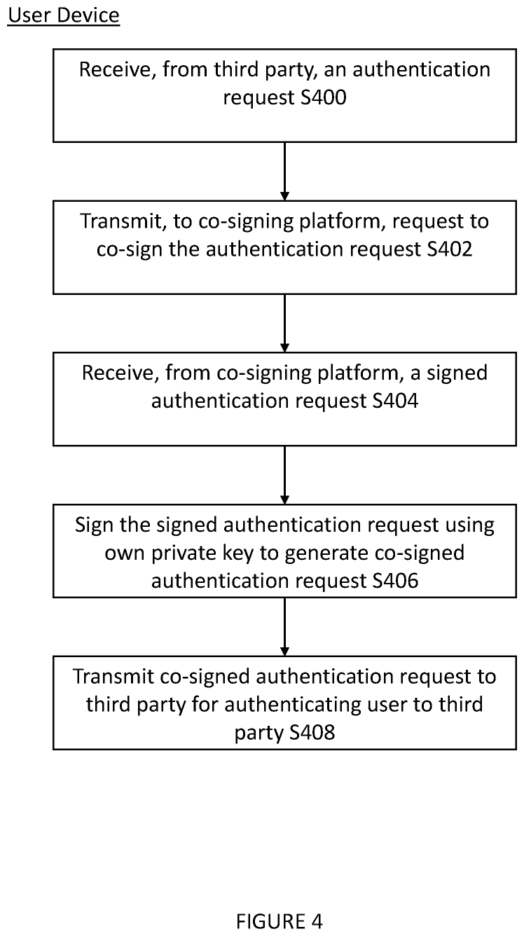

FIG. 4 shows a flowchart of example steps performed by a user device to authenticate a user of the user device using multi-party authentication; and

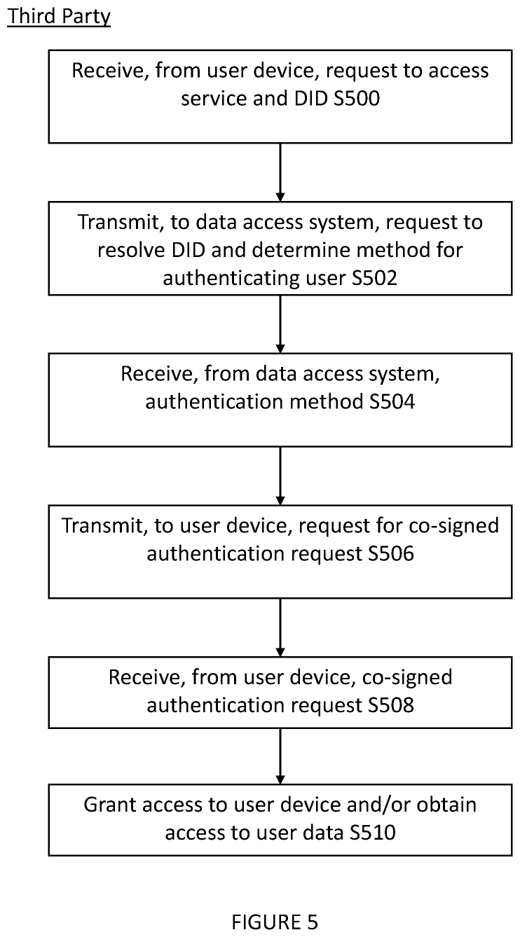

FIG. 5 shows a flowchart of example steps performed by a third party system to authenticate a user using multi-party authentication.

Broadly speaking, embodiments of the present techniques provide systems and methods for authenticating users using a distributed identity (DID) document. In particular, the present techniques provide systems and methods for multi-party authentication of users using distributed identity documents for enhanced security.

FIG. 1 shows a block diagram of a system 500 for authenticating a user to a third party using a distributed identity document. The system 500 comprises a user device 502, a third party system or service 504, and a co-signing platform 102. In order for the user to authenticate themselves to a third party, the user device 502 (and user) needs to be registered with the co-signing platform 102. Thus, prior to the co-signing platform 102 being able to co-sign authentication requests for a user, the user must register with the co-signing platform 102. The co-signing platform 102 may perform an initial registration process, which may comprise: receiving, from a user, a registration request; prompting the user to generate at least one public-private key pair; requesting, from the user, the public key of each generated public-private key pair; and storing (in storage 102a) each received public key in association with the user.

The user may already have created distributed identity documents (DIDs), which may be stored in a data access platform or DID storage platform. The user may need to update their existing DIDs to include information about the new co-signing authentication method within the DIDs. This may comprise removing any existing authentication methods from the DIDs. Thus, the user may contact an external data access platform or external DID storage platform (e.g. data access platform 108) which stores the user's DIDs to update the DIDs to contain/specify the new authentication method, so that a third party viewing a DID would know how to authenticate the user.

In some cases, the co-signing platform 102 may be part of a system which also stores DIDs for users. Thus, system 500 may comprise a system 100, where system 100 comprises both a co-signing platform 102 and a data access platform 108. The data access platform 108 may be accessed by users (to store, modify and revoke DIDs) and third parties (to access a DID) in any suitable way, e.g. via a software application (app′) or via a web browser. In this case, the method may further comprise: receiving, from the user, a distributed identity document comprising an associated authentication method to be used by a third party to authenticate the user; and storing the received distributed identity document in storage 108a of the data access platform 108. Alternatively, the method may comprise: receiving, from the user, an updated distributed identity document comprising an associated authentication method to be used by a third party to authenticate the user; and replacing an existing distributed identity document in storage 108a with the updated distributed identity document.

The co-signing platform 102 and data access platform 108 may each comprise one or more interfaces (not shown in FIG. 1) to enable the platforms to receive inputs (e.g. requests from a user or third party) and provide outputs (e.g. responses to the requests). The interface of the co-signing platform 102 may comprise a user interface. The interface of the data access platform 108 may comprise a user interface and a third party interface.

Each platform 102 and 108 may comprise at least one processor or processing circuitry for carrying out any of the methods described herein. The processor may comprise one or more of: a server, a microprocessor, a microcontroller, and an integrated circuit.

Once registered with the co-signing platform 102, the user's public keys (i.e. keys associated with each device they use) are stored in the storage 102a of the co-signing platform. The co-signing platform 102 may receive, from the user, a set of policies specifying conditions under which a co-signing request from the user would be valid, and information specifying one or more public keys to be associated with the set of policies. For example, the user can set or provide policies specifying when the co-signing platform 102 should or should not co-sign an authentication request for the user. By default, the co-signing platform 102 may not co-sign authentication requests when the co-signing request appears to be suspicious. In some cases, the co-signing platform 102 may itself is determine a co-signing request to be suspicious. The set of policies (general or device/key-specific) may be stored in storage 102b.

The system 100 may determine suspicious or dangerous authentication requests itself, instead of or in addition to relying on the policies to make the determination. This determination may be performed by the co-signing platform 102. Artificial intelligence (AI) may be used to help with such detection. In this implementation, the co-signing platform 102 may also comprise an AI module, as shown in FIG. 1. The function of the AI module is to determine whether the authentication request is suspicious. The system 100 does not try to detect fraudulent transactions, but the system 100 may instead detect suspicious login attempts/authentication or data requests. Thus, beneficially, AI module of the co-signing platform 102 may protect users against dangerous usage of or unauthorised access to their personal data.

For instance, a third party site with a low Trust Pilot rating may request access to a user's location data over the last ten months, the user's average income, and the user's spending data on jewellery (i.e. access to the user's personal data). The system 100 may determine that this third party request is suspicious and therefore the system 100 may output, for instance, a questionnaire to help the user of user device 102 understand the risks associated with the authentication request received from this third party. The system 100, upon detection/determination of a suspicious authentication request, may output an additional security measure, e.g. a questionnaire, a phone call to the user, an email to the user, a text message to the user, or any other similar technique to alert the user to the fact the authentication request appears to be malicious or risky. The user is therefore being asked to double-check whether the authentication request should really be signed by the co-signing platform prior to signing and returning the signed authentication request to the user device.

Advantageously, while the co-signing platform provides security benefits to the user and user device, the co-signing platform also takes some risk away from the third party. This is because the third party is able to outsource some security checks to the co-signing platform. This may be beneficial to the third party because the security checks enable the third party to, for example, be sure they are dealing with the genuine, intended user.

The additional security measure may be specified in a policy that is set by the user. The determination on whether the authentication request is suspicious may be done with the help of the AI module. For instance, if a user receives an authentication request from a third party that is determined to be suspicious regularly, but the user always accepts the authentication requests from this particular third party and proceeds with the authentication process, the co-signing platform 102 may learn from this behaviour to stop categorizing requests from this platform as suspicious. The determination on whether the authentication request from a third party is suspicious may be determined based on previous user actions and/or reputability/rating of the third party.

Dangerous seeming authentication requests could be silently ignored by the co-signing platform (i.e. the co-signing platform simply does not sign the authentication request). Additionally or alternatively, dangerous seeming authentication requests could be silently accepted by the co-signing platform (i.e. the co-signing platform signs the authentication request without querying the user first) if the platform considers it to be acceptable or harmless to the user. For example, if the authentication request contains a message from the third party that appears to be offering the user a free lunch or discount in exchange for a piece of user data that is considered harmless to provide, the co-signing platform may simply sign the request.

In the context of genome data, which is very personal user data, a user may permit certain websites with certain genomic data, such as a subset of the user's metabolic gene data. However, if the website is also requesting information on the user's single nucleotide polymorphisms (SNPs), which could potentially relate to sensitive medical conditions such as Alzheimer's Disease, the co-signing platform (e.g. the AI module thereof) may determine that the request is problematic. In this case, the authentication request may be queried with the user prior to signing by the co-signing platform, using the additional security measure explained above.

The co-signing platform 102 also contains the co-signing platform's private key (of a public-private key pair).

The co-signing platform 102 may authenticate users using distributed identity documents by firstly receiving, from a user device 502, a co-signing request to co-sign an authentication request received from a third party service provider 504. The co-signing platform 102 may determine whether the user and the co-signing request are valid, and if so, may sign the authentication request using the stored private key of the co-signing platform. The co-signing platform 102 then transmits the signed authentication request to the user for signing (co-signing) by the user.

The co-signing platform 102 may sign authentication requests received from users, revoke lost keys, and enable recovery of access to users' accounts when keys are lost. In cases when a key is lost or stolen, a user may want to remove existing allowed signing keys from the co-signing platform. The user can remove registered devices (keys) from their account with the platform. The user may use another (uncompromised) device to initiate the removal request. A removal request message sent by the user is stored by the platform in the user's account. The user may need to perform additional, policy-specific authentication steps in order to make the removal request valid. The platform will then remove the key from the stored keys associated with the user. Thus, if the platform receives a request from the user comprising a public key that has been revoked by the user, the platform may determine that the request is not valid and may refuse to co-sign.

The user may use their user device 502 to access a service provided by the third party 504 (as represented by arrow A), and presents a DID in order to gain access to the service. The third party 504 may wish to control access to its services. If the third party 504 holds user data, the user may require the third party to control who accesses the third party's services so that their data does not end up in the hands of someone who is not authorised by the user to have their data. Thus, when the user presents the DID, the third party sends a request to the data access system 108 to resolve the DID and determine the method for authenticating the user (as represented by arrow B). The data access system 108 may obtain this method from storage and provide it to the third party 504 (as represented by arrow C).

The authentication method associated with the user's DID may require the user to provide an authentication request to be signed by the user and a trusted third party, i.e. the co-signing platform 102. The authentication request may simply be in some instances a multi-party signature (i.e. a signature formed of two or more signatures of different entities). Thus, the third party 504 may send a request to the user device 502 for the signed authentication request to authenticate the user (as represented by arrow D). Thus, multi-party authentication may be achieved. The authentication method may use a multisig (also called multisignature) to build a challenge response login.

Thus, the user device 502 may receive from the third party, in response to an attempt by a user to access a service provided by the third party, a request for the user to authenticate themselves using an authentication method contained in a distributed identity document.

The user device may blind the authentication request prior to transmitting the authentication request to the co-signing platform 102. To prevent the co-signing platform 102 from seeing the identity of every entity the user interacts with, the authentication request may be blinded before it is transmitted by the user device. The anonymity/blinding may be achieved by performing cryptographic message blinding, a technique introduced by David Chaum. In this technique, an authentication message may be disguised (also referred to as ‘blinded’) by an application running on the user device, before the authentication request is sent to the co-signing platform. Alternatively, the user and the third party may establish transient keys, and use those for signing by the co-signing platform.

The user device 502 may transmit, to the co-signing platform 102, a request to co-sign an authentication request for the third party, the authentication request comprising a message from the third party (as represented by arrow E). The method performed by the co-signing platform is described below with respect to FIG. 2.

The user device 502 may receive, from the co-signing platform 102, a signed authentication request that has been signed using a private key of a public-private key of a key pair of the co-signing platform (as represented by arrow F). The user device 502 may sign the signed authentication request using a private key of a public-private key pair (or device key) belonging to the user to generate a co-signed authentication request. The user device 502 may transmit the co-signed authentication request to the third party 504 (as represented by arrow G). If the user device had blinded the authentication request before signing, the user device may unblind the co-signed authentication request prior to transmitting the co-signed authentication request to the third party.

The third party 504 may perform a check to determine the validity of the signatures, and if valid, the third party 504 may grant access to the user (as represented by arrow H).

The process described so far may be summarised as follows:
The process may begin with a user registration process.
The user attempts, using their user device, to access a service provided by a third party.
The third-party sends an authentication request to the user device to require the user to authenticate themselves. This authentication request may be considered “the first request”, and the terms are used interchangeably herein.
The user device sends a co-signing request to the co-signing platform, so that the authentication request (i.e. the first request) can be co-signed. This co-signing request may be considered “the second request”, and the terms are used interchangeably herein.
The co-signing platform determines the validity of the second request.
If the second request is valid, the co-signing platform signs the first request using a private key of a public-private key pair of the co-signing platform. This signing may be considered “the first signature”.
The co-signing platform sends the signed first request to the user device.
The user device co-signs the signed first request by using a private key of a public-private key pair belonging to the user. This signing may be considered “the second signature”.
The user sends the co-signed first request to the third party, for the third party to authenticate/verify the user.

Thus, the method for authenticating users using an authentication technique specified in distributed identity documents, may comprise: receiving, from the user, a second request to co-sign a first request for a third party, the first request comprising a message from the third party; determining whether the user and the second request are valid; co-signing the first request, when the user and second request are determined to be valid, using a private key of a public-private key of a key pair of a co-signing platform; and transmitting the signed first request to the user for co-signing by the user.

Similarly, the method for authenticating a user to a third party, may comprise: receiving from a third party, in response to an attempt by a user to access a service provided by the third party, a first request for the user to authenticate themselves using an authentication method contained in a distributed identity document; transmitting, to a co-signing platform, a second request to co-sign the first request for the third party; receiving, from the co-signing platform, a signed first request that has been signed using a private key of a public-private key pair of a co-signing platform; signing the signed first request using a private key of a public-private key pair belonging to the user to generate a co-signed first request; and transmitting the co-signed first request to the third party.

FIG. 2 shows a schematic diagram illustrating example steps performed by the identity authentication platform to authenticate a user using a distributed identity document.

The process begins when, as explained above, the third party 504 requests the user to authenticate themselves (step S600). The user 502 transmits a request to the co-signing platform 102 to co-sign an authentication request (S602). The co-signing platform 102 receives, from the user 502, the request to co-sign an authentication request for the third party 504, the authentication request comprising a message from the third party 504.

The co-signing platform 102 may determine whether the user and the request are valid. The co-signing platform may transmit, to the user, a failure message when one or both of the user and the request are determined to be invalid. Determining if the user is valid may comprise determining if the user is a registered user.

Once the user has been determined to be valid, the platform 102 may check the validity of the request itself. The validity of the request may be determined in a number of ways. For example, if the request received from the user 502 comprises a public key of a public-private key pair belonging to the user, the co-signing platform 102 may determine whether the public key of the user matches a stored public key (in storage 102a) belonging to the user. A user may have created a plurality of public-private key pairs (e.g. one key pair for each device they use), and provided the public keys of the key pairs to the platform 102 for association with the user. As noted above, these public keys are stored in storage 102a. The user may use any of these keys when signing the authentication request. The platform can check if the public key sent with the request belongs to the user.

Furthermore, the user may have informed the platform that one or more keys need to be revoked. In cases when a key is lost or stolen, a user may want to remove existing allowed signing keys from the co-signing platform. The user can remove registered devices (keys) from their account with the platform. The user may use another (uncompromised) device to initiate the removal request. A removal request message sent by the user is stored by the platform in the user's account. The user may need to perform additional, policy-specific authentication steps in order to make the removal request valid. Depending on the user policy, the platform will then remove the key from the stored keys associated with the user. Thus, if the user request comprises a key that has been revoked by the user, the platform may determine that the request is not valid and may refuse to co-sign the authentication request.

Determining whether the request is valid may comprise obtaining, from storage 102b, a set of policies associated with the user, the set of policies specifying conditions under which a request from the user would be valid. For example, the user can set or provide policies specifying when the co-signing platform should or should not co-sign an authentication request for the user. By default, the co-signing platform may not co-sign authentication requests when the co-signing request appears suspicious or is determined to be suspicious by the co-signing platform (AI module) itself.

The user has the best knowledge about what would be improved or acceptable security for them, and therefore, the platform may enable the user to specify allowed regions, IP addresses or devices from which requests would be acceptable, or times of day when co-signing requests would be expected from the user. Policies may be applied on a per-key basis, allowing different devices to have different limitations. The policies may also specify out-of-band security measures. As a simple example, the user may want the platform to provide an interactive challenge such as a password challenge, biometric challenge or a time-based, one-time password (TOTP) challenge to determine that the request has originated from the user and not from a malicious third party. A more advanced security measure may involve a telephone call to the user to validate the request.

For example, a user may be abroad and may need to update a detail about their driver's license with the DVLA. The user attempts to log in to their account with the DVLA (i.e. a third party), but the co-signing step fails because the co-n signing platform may not sign authentication requests when suspicious behaviour is detected to help prevent fraud. In this case, the request for the co-signing platform to co-sign the authentication request may arrive from a location that is not permitted in the user's policies. The user may need to take further measures to temporarily permit their current location, so that the co-signing platform is able to co-sign the authentication request.

In another example, a user wants to access their personal data store to add another entry to their journal and diary. The user normally only accesses their journal from their home in the evening, using their desktop PC. This user has provided a policy rule that only enables their desktop device to log in between the hours of 7 pm and 11 pm.

Thus, the co-signing platform may: compare metadata associated with the received request with a set of policies; and determine if the received request is valid if the metadata complies with the set of policies. The set of policies may comprise any one or more of: time of request receipt, at least one time period during which co-signing is permitted, at least one time period during which co-signing is not permitted, origin of request, geographical origin of request, device used to send request, at least one approved user device, and at least one accepted IP address. Additionally or alternatively, the set of policies may comprise at least one out-of-band security challenge to be correctly completed by the user to determine if the received request is valid.

Returning to FIG. 2, the co-signing platform 102 may sign the authentication request when the user and request are determined to be valid, using a private key of a public-private key of a key pair of the co-signing platform (step S606). When signed, the co-signing platform may transmit the signed authentication request to the user (S608) for signing (co-signing) by the user. The user device 502 may sign the signed authentication request using a private key of a public-private key pair belonging to the user to generate a co-signed authentication request, and may transmit the co-signed authentication request to the third party 504 to gain access to the desired service (S610).

As explained above, the user is the custodian of their own data and the present techniques enable the user to control who accesses that data. The user's data may be accessed when the user is using the services of a third party, for example. The third party 504 may therefore be granted access to specific user data, by the user, so that the user can access the services provided by the third party.

For instance, a user may visit a website that sells shoes (e.g. shoesforpatentattorneys.com) and clicks ‘browse for shoes’. At this point, the website may ask, ‘look for shoes in your size and local to you?’ and may present a QR code. Thus, the third party operating the website is asking the user whether the user will provide the website with certain user data to enable enhanced browsing. The user may scan the QR code to determine what specific user data the third party is requesting. For example, this may reveal that “shoesforpatentattorneys.com [symbol] would like to access your shoe size and approximate location”. Note the padlock in the request is the certificate check from the DNS system's Publick Key Infrastructure (PKI) that can be seen in browsers but re-purposed for the ‘authentication request’ in the application of the present techniques. The user can answer yes or no. For example, at this stage, the user could decide that they do not want to grant this particular website/third party with this specific data and so the user may be permitted to browse for shoes in a more usual manner. There can be various pathways downstream of either choice which depend on the policy set by the user. For instance, if the user answers yes, the co-signing platform may then, for instance, call the user to check if it was really the user that answered “yes”. If the user had a different policy in place, upon answering “yes”, the co-signing platform may accept this request on behalf of the user without ever even prompting a notification. Thus, advantageously, the security measures performed by the co-signing platform may be set by each user.

FIG. 3 shows a flowchart of example steps performed by a co-signing platform to authenticate a user using multi-party authentication. The method may comprise receiving, from a user, a co-signing request to co-sign an authentication requestfor a third party service provider (step S300). The authentication request may comprise a message from the third party service provider specifying that the third party requires the user to be authenticated or that the third party requires access to user data belonging to the user.

The method may comprise determining whether the user and the co-signing request are valid (step S302). For example, if the user is not a registered user, the co-signing platform may not be able to co-sign the authentication request because the user is unknown to the platform. Thus, determining whether the user is valid may comprise determining whether the user is registered with the co-signing platform. Once the user has been determined to be valid, the platform may check the validity of the co-signing request itself, as explained above.

The method may comprise signing the authentication request, when the user and request are determined to be valid, using a private key of a public-private key of a key pair of the co-signing platform (step S304).

The method may comprise transmitting the signed authentication request to the user for signing by the user for authenticating the user to the third party (step S306).

FIG. 4 shows a flowchart of example steps performed by a user device to authenticate a user of the user device using multi-party authentication. The method may comprise: receiving from a third party, in response to an attempt by a user to access a service provided by the third party, an authentication request for the user to authenticate themselves using an authentication method contained in a distributed identity document (step S400). The authentication request may comprise a message from the third party specifying that the third party requires the user to be authenticated or that the third party requires access to user data belonging to the user.

The method may comprise transmitting, to a co-signing platform, a co-signing request to co-sign the authentication request for the third party (step S402).

The method may comprise receiving, from the co-signing platform, a signed authentication request that has been signed using a private key of a public-private key pair of a co-signing platform (step S404).

The method may comprise signing the signed authentication request using a private key of a public-private key pair belonging to the user to generate a co-signed authentication request (step S406).

The method may comprise transmitting the co-signed authentication request to the third party for authenticating to the third party (step S408).

When the message in the authentication request specifies that the third party requires the user to be authenticated, the method may further comprise: receiving, from the third party, permission to access the service provided by the third party, following receipt by the third party of the co-signed authentication request. Alternatively, when the message in the authentication request specifies that the third party requires access to user data belonging to the user, the method may further comprise: providing, to the third party, access to specific user data stored in a user data store.

FIG. 5 shows a flowchart of example steps performed by a third party system to authenticate a user using multi-party authentication. The method may comprise receiving, from a user device, a request to access a service provided by and/or data held by the third party system (step S500). The request may comprise or be accompanied by the user's DID.

The method may comprise transmitting, to a data access system, a request to resolve the DID and thereby determine a method for authenticating the user (step S502).

The method may comprise receiving, from the data access system, an authentication method specified within the user's DID (step S504). The authentication method associated with the user's DID may require the user to provide an authentication request to be signed by the user and a trusted third party, i.e. the co-signing platform. The authentication request may simply be in some instances a multi-party signature (i.e. a signature formed of two or more signatures of different entities).

The method may therefore comprise transmitting, to the user device, a request for a co-signed authentication request (step S506). The user device and co-signing platform then perform the co-signing process described above. The request sent by the third party may comprise a message specifying that the third party requires the user to be authenticated, or that the third party requires access to user data belonging to the user in order to provide the user with the requested service/data.

The method may comprise receiving, from the user device, a co-signed authentication request (step S508).

The method may comprise granting access to the user device to the requested service or data, and/or may comprise obtaining access to user data required to provide the user with the requested service (step S510).

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A method performed by a co-signing platform, for authenticating users using a multi-party authentication technique specified in a distributed identity document, the method comprising:
receiving, from a user among the users, a co-signing request to co-sign an authentication request for a third party, the authentication request including a message from the third party specifying that the third party requires the user to be authenticated or that the third party requires access to user data belonging to the user;
determining whether the user and the co-signing request are valid;
signing the authentication request, when the user and the co-signing request are determined to be valid, using a private key of a public-private key of a key pair of the co-signing platform; and
transmitting the signed authentication request to the user for signing by the user for authenticating to the third party.

2. The method as claimed in claim 1 further comprising:
transmitting, to the user, a failure message in response to the user or the co-signing request being invalid.

3. The method as claimed in claim 1 wherein determining whether the user is valid includes:
determining whether the user is registered with the co-signing platform,
wherein the co-signing request includes a signature of the request generated using the private key of a public-private key pair belonging to the user, and in response to the user being registered with the co-signing platform, determining whether the signature has been signed with a key corresponding to a stored public key belonging to the user.

4. (canceled)

5. The method as claimed in claim 1 wherein determining whether the co-signing request is valid includes:
obtaining, from storage, a set of policies associated with the user, the set of policies specifying conditions under which the co-signing request from the user is valid.

6. The method as claimed in claim 5 further comprising:
comparing metadata associated with the co-signing request with the set of policies; and
determining whether the co-signing request is valid based on whether the metadata complies with the set of policies.

7. The method as claimed in claim 5, wherein the set of policies includes one of:
a time of request receipt, at least one time period during which co-signing is permitted, at least one time period during which co-signing is not permitted, an origin of request, a geographical origin of request, a device used to send the request, at least one approved user device, a datatype, and at least one accepted IP address or
at least one out-of-band security challenge to be completed by the user to determine whether the co-signing request is valid.

8. (canceled)

9. The method as claimed in claim 5 wherein the set of policies is associated with:
each public key belonging to the user or
the private key used by the user to sign the distributed identity document.

10. (canceled)

11. The method as claimed in claim 1 wherein determining whether the co-signing request is valid comprises determining, using an artificial intelligence model, whether the co-signing request is suspicious.

12. The method as claimed in claim 1 further comprising:
receiving, from the user, a registration request;
prompting the user to generate at least one public-private key pair;
requesting, from the user, a public key of each generated public-private key pair; and
storing each public key in association with the user.

13. The method as claimed in claim 12 further comprising:
receiving, from the user, a distributed identity document comprising an associated authentication method to be used by a third party to authenticate the user; and
storing the received distributed identity document.

14. The method as claimed in claim 12 further comprising:
receiving, from the user, a set of policies specifying conditions under which the co-signing request from the user would be valid and information specifying one or more public keys to be associated with the set of policies; and
storing the set of policies.

15. The method as claimed in claim 1 further comprising:
receiving, from the third party, a request for a distributed identity document for the user seeking to access a service provided by the third party, the request comprising information identifying the user;
identifying, using the information identifying the user, a distributed identity document corresponding to the user in storage; and
transmitting the distributed identity document to the third party, the distributed identity document comprising an authentication method for the third party to authenticate the user.

16. A system for authenticating users using a multi-party authentication technique specified in distributed identity documents, the system comprising:
a co-signing platform including:
storage for public keys and policies associated with each user of the system; and
at least one interface coupled to a processor for:
receiving, from a user among the users, a co-signing request to co-sign an authentication request for a third party, the authentication request comprising a message from the third party specifying that the third party requires the user to be authenticated or that the third party requires access to user data belonging to the user;
determining whether the user and the co-signing request are valid;
signing the authentication request, in response to the user and co-signing request to being valid, using a private key of a public-private key of a key pair of the co-signing platform; and
transmitting the signed authentication request to the user for signing by the user for authenticating to the third party.

17. (canceled)

18. (canceled)

19. The system as claimed in claim 16 further comprising:
a data access platform comprising:
storage for storing at least one distributed identity document associated with each user of the system;
at least one interface coupled to the processor for:
receiving, from a user, a distributed identity document comprising an associated authentication method to be used by a third party to authenticate the user; and
storing the received distributed identity document.

20. The system as claimed in claim 19 wherein the at least one interface and the processor of the data access platform are further configured to:
receive, from the third party, a request for a distributed identity document for a user seeking to access a service provided by the third party, the request comprising information identifying the user;
identify, using the information identifying the user, a distributed identity document corresponding to the user in the storage of the data access platform; and
transmit the distributed identity document to the third party, the distributed identity document comprising an authentication method for the third party to authenticate the user.

21. The system as claimed in claim 19, wherein the at least one interface and the processor of the data access platform are further configured to:
receive, from the user, a distributed identity document comprising the associated authentication method to be used by the third party to authenticate the user; and
storing the received distributed identity document in the storage of the data access platform.

22. The system as claimed in claim 16, further comprising a user device comprising a communication module coupled to the processor and configured to:
receive from the third party, in response to an attempt by a user to access a service provided by the third party, an authentication request for the user to authenticate themselves using an authentication method contained in a distributed identity document, wherein the authentication request includes a message from the third party specifying that the third party requires the user to be authenticated or that the third party requires access to user data belonging to the user;
transmit, to the co-signing platform, a request to co-sign the authentication request for the third party;
receive, from the co-signing platform, a signed authentication request that has been signed using the private key of the public-private key of the key pair of the co-signing platform;
sign the signed authentication request using a private key of a public-private key pair belonging to the user to generate a co-signed authentication request; and
transmit the co-signed authentication request to the third party for authenticating to the third party.

23. The system as claimed in claim 22 wherein:
in response to the message in the authentication request specifying that the third party requires the user to be authenticated, the user device is configured to:
receive from the third party a permission to access the service provided by the third party, following receipt by the third party of the co-signed authentication request, or
when the message in the authentication request specifies that the third party requires access to user data belonging to the user, the user device is configured to: provide, to the third party, access to specific user data stored in a user data store.

24. (canceled)

25. A method performed by a user device, for authenticating a user to a third party, the method comprising:
receiving from the third party, in response to an attempt by the user to access a service provided by the third party, an authentication request for the user to authenticate themselves using an authentication method contained in a distributed identity document, wherein the authentication request comprises a message from the third party specifying that the third party requires the user to be authenticated or that the third party requires access to user data belonging to the user;
transmitting, to a co-signing platform, a request to co-sign the authentication request for the third party;
receiving, from the co-signing platform, a signed authentication request that has been signed using a private key of a public-private key pair of the co-signing platform;
signing the signed authentication request using a private key of a public-private key pair belonging to the user to generate a co-signed authentication request; and
transmitting the co-signed authentication request to the third party for authenticating to the third party.

26. The method as claimed in claim 25 further comprising:
blinding the authentication request prior to transmitting to the co-signing platform; and
unblinding the signed authentication request prior to signing and transmitting the co-signed authentication request to the third party.

27-33. (canceled)
